(19) United States
(12) Patent Application Publication
(10) Pub. No.: US 2010/0315511 A1
(43) Pub. Date: Dec. 16, 2010

(54) Image capturing device

(75) Inventors: Kai-Hsiang Tsao, Hsin-Chu (TW); Han-Jen Pai, Hsin-Chu (TW)

Correspondence Address: BACON & THOMAS, PLLC, 625 SLATERS LANE, FOURTH FLOOR, ALEXANDRIA, VA, 22314-1176, US

(73) Assignee: YOUNG OPTICS INC., Hsin-Chu (TW)

(21) Appl. No.: 12/801,358

(22) Filed: Jun. 4, 2010

(30) Foreign Application Priority Data
Jun. 12, 2009 (TW) 098119660

(51) Int. Cl. H04N 5/33; H04N 5/228

(52) U.S. Cl. 348/164; 348/222.1; 348/E09.053; 348/E05.09

(57) ABSTRACT

An image capturing device includes a lens module, a filter, two sensors, a first image processing module, and a second image processing module. The lens module is adapted to receive the image beam. The filter is adapted to split the image beam into a first beam and a second beam. The two sensors are disposed in transmission paths of the first beam and the second beam separately, and the sensors separately convert the first beam and the second beam into a first optical information and a second optical information. The first image processing module and the second image processing module are disposed in transmission paths of the first optical information and the second optical information separately, and the image processing modules separately convert the optical information into image information. The second image processing module integrates the first image information and the second image information into a color image.

### BACKGROUND OF THE INVENTION

(1) Field of the Invention

The invention relates to an image capturing device, and especially relates to an image capturing device with brightness compensating.

(2) Description of the Related Art

Refer to FIG. 1 and FIG. 2 for schematic views of conventional image capturing devices 101 and 102. The image capturing devices 101 and 102 are adapted to capture image beams from external environment, respectively include a lens module 110, a sensor 150, and an image processing module 160. The lens module 110 includes a lens 120 and an infrared light blocking device 130. The image beam includes an infrared light beam R1 and a visible light beam R2.

To keep color correct, the image capturing device 101 does not allow the infrared light R1 to enter the sensor 150, so the infrared light blocking device 130 is disposed at back side of the lens 120 of the lens module 110. Most of the image capturing device 101 of the consumption type applies the above mentioned method. As FIG. 1 shows, the lens 120 receives the infrared light R1 and the visible light R2. The infrared light blocking device 130 is disposed in transmission paths of the infrared light R1 and the visible light R2 to prevent the infrared light R1 entering the sensor 150. The sensor 150 is disposed in a transmission path of the visible light R2 to receive the visible light R2 and convert the visible light R2 into a visible light optical information R2′. The image processing module 160 is disposed in a transmission path of the visible light optical information R2′ for restoring the visible light optical information R2′ into a color image.

As FIG. 2 shows, the infrared light blocking device 130 uses a switch, so that the image capturing device 102 may choose the infrared light R1 to enter the sensor 150 or not. In common environment, the infrared light blocking device 130 is switched on, so the imaging situation may be the same as the image capturing device 101 in FIG. 1. When the image capturing device 102 works at night or in low brightness environment, the infrared light blocking device 130 is switched off to let the infrared light R1 enter the sensor 150. The sensor 150 receives the infrared light R1 and the visible light R2 and then converts the infrared light R1 and the visible light R2 into a mixed infrared and visible light information (R1′+R2′). After the image processing module 160 receives the infrared light optical information R1′, the image processing module 160 is unable to restore the image of the visible light R2 into real color because of the influence of the infrared light optical information R1′. The infrared light blocking device 130 is usually used in a monitor-type image capturing device and uses the infrared light R1 as auxiliary lighting.

However, at night or in low brightness environment, with less visible light, the image capturing ability of the conventional image capturing device 101 may not be good. When the image capturing device 102 works at night or in low brightness environment, the image restored by the image processing module 160 may not be able to display real color. Hence, how to make the image capturing devices 101 and 102 restore correct color after the infrared light R1 entering the conventional image capturing devices 101 and 102 is an urgent problem in the field.

### SUMMARY OF THE INVENTION

Accordingly, the object of the invention is to provide an image capturing device for restoring the image to correct color and compensating the image for lack of the brightness.

In one aspect, an embodiment of the invention provides an image capturing device adapted to capturing an image beam includes a lens module, a filter, two sensors, a first image processing module, and a second image processing module.

The lens module is adapted to receive the image beam. The filter is disposed in a transmission path of the image beam received by the lens module, and adapted to split the image beam into a first beam and a second beam. The two sensors are disposed in transmission paths of the first beam and the second beam separately, and the sensors separately convert the first beam and the second beam into a first optical information and a second optical information. The first image processing module is disposed in a transmission path of the first optical information and adapted to convert the first optical information into a first image information. The second image processing module is disposed in a transmission path of the second optical information, and adapted to convert the second optical information into a second image information and integrate the first image information and the second image information to output a color image.

In an embodiment, the first beam has a first band, the second beam has a second band, and the first band is different from the second band. The first band is wavelength range of an infrared light, and the second band is wavelength range of a visible light. Wherein the first image information includes a brightness information, and the second image information includes a brightness information and a chroma information.

In an embodiment, the second image processing module includes a color restoration module and an image integration module. Wherein the color restoration module is disposed in the transmission path of the second optical information and adapted to convert the second optical information into the second image information, and the image integration module is disposed in the transmission paths of the first image information and the second image information and adapted to integrate the first image information and the second image information to output the color image.

In an embodiment, the image capturing device further includes an optical module, the optical module is disposed in the transmission path of the image beam received by the lens module and located between the lens module and the filter, and the optical module is adapted to correct a position of the image beam on the filter.

In an embodiment, the image capturing device further includes two optical modules, the optical modules are separately disposed in the transmission paths of the first beam and the second beam split by the filter and respectively located between the filter and the sensors, and the optical modules are adapted to correct positions of the first beam and the second beam on the sensors separately.

Compared to the conventional, the installation of the filter makes plural image processing modules respectively process the optical information with different bands and convert the optical information of the infrared light into the brightness information for compensating the image for lack of the brightness and restoring the image to good color in the embodiments of the invention

Other objectives, features and advantages of the invention will be further understood from the further technological features disclosed by the embodiments of the invention wherein there are shown and described preferred embodiments of this invention, simply by way of illustration of modes best suited to carry out the invention.

### BRIEF DESCRIPTION OF THE DRAWINGS

FIG. 1 is a schematic view of a conventional image capturing device.

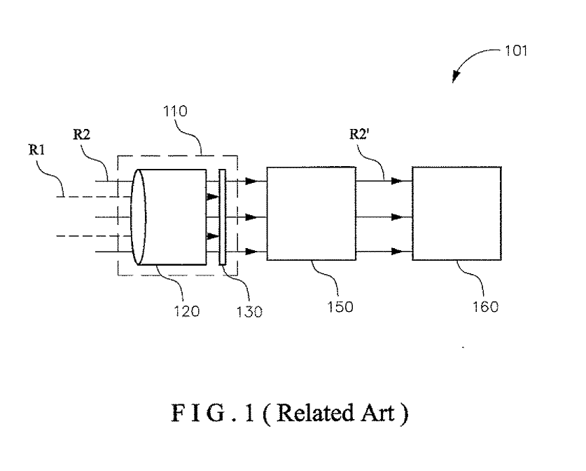

FIG. 2 is a schematic view of another conventional image capturing device.

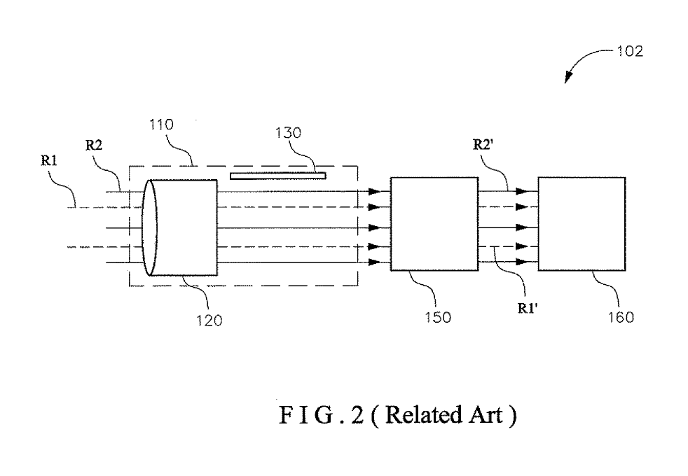

FIG. 3 is a schematic view of an image capturing device according with the first embodiment of the invention.

FIG. 4 is a schematic view of an image capturing device according with the second embodiment of the invention.

FIG. 5 is a schematic view of an image capturing device according with the third embodiment of the invention.

### DESCRIPTION OF THE PREFERRED EMBODIMENTS

In the following detailed description of the preferred embodiments, reference is made to the accompanying drawings which form a part hereof, and in which is shown by way of illustration specific embodiments in which the invention may be practiced. In this regard, directional terminology, such as “top,” “bottom,” “front,” “back,” etc., is used with reference to the orientation of the Figure(s) being described. The components of the invention can be positioned in a number of different orientations. As such, the directional terminology is used for purposes of illustration and is in no way limiting. On the other hand, the drawings are only schematic and the sizes of components may be exaggerated for clarity. It is to be understood that other embodiments may be utilized and structural changes may be made without departing from the scope of the invention. Also, it is to be understood that the phraseology and terminology used herein are for the purpose of description and should not be regarded as limiting. The use of “including,” “comprising,” or “having” and variations thereof herein is meant to encompass the items listed thereafter and equivalents thereof as well as additional items. Unless limited otherwise, the terms “connected,” “coupled,” and “mounted” and variations thereof herein are used broadly and encompass direct and indirect connections, couplings, and mountings. Similarly, the terms “facing,” “faces” and variations thereof herein are used broadly and encompass direct and indirect facing, and “adjacent to” and variations thereof herein are used broadly and encompass directly and indirectly “adjacent to”. Therefore, the description of “A” component facing “B” component herein may contain the situations that “A” component directly faces “B” component or one or more additional components are between “A” component and “B” component. Also, the description of “A” component “adjacent to” “B” component herein may contain the situations that “A” component is directly “adjacent to” “B” component or one or more additional components are between “A” component and “B” component. Accordingly, the drawings and descriptions will be regarded as illustrative in nature and not as restrictive.

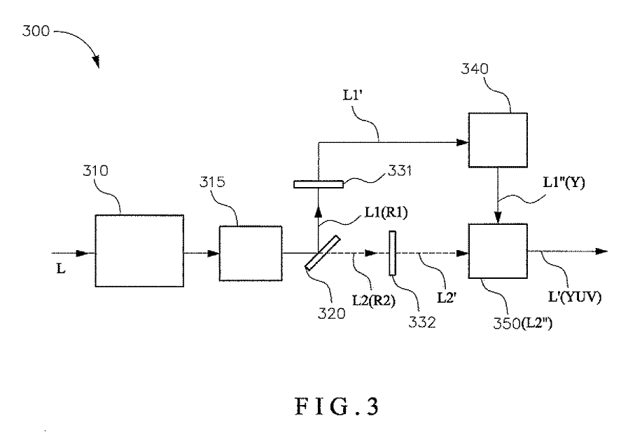

Refer to FIG. 3 for a schematic view of an image capturing device 300 in accordance with the first embodiment of the invention. The image capturing device 300 is adapted to capture an image beam L from external environment and includes a lens module 310, a filter 320, two sensors 331 and 332, a first image processing module 340, and a second image processing module 350.

The lens module 310 is adapted to receive the image beam L. The to filter 320 is disposed in the transmission path of the image beam L received by the lens module 310, and adapted to split the image beam L into a first beam L1 and a second beam L2. The filter 320 reflects the first beam L1 and enables the second beam L2 to penetrate. The first beam L1 has a first band, and the first band is the wavelength range of an infrared light R1. The second beam L2 has a second band, and the second band is the wavelength range of a visible light R2.

In an embodiment, the image capturing device 300 further includes an optical module 315. The optical module 315 is disposed in the transmission path of the image beam L received by the lens module 310 and located between the lens module 310 and the filter 320, so as to compensate the loss of the image beam L and amend a position of the image beam L on the filter 320. Thus the first beam L1 and the second beam L2 split from the image beam L are focused on the sensors 331 and 332 separately to avoid the out-of-focus problem of a color image L′ generated by the image capturing device 300.

Two sensors 331 and 332 are disposed in the transmission paths of the first beam L1 and the second beam L2 separately. The sensor 331 receives the first beam L1 reflected by the filter 320 and converts the first beam L1 into a first optical information L1′. The sensor 332 receives the second beam L2 penetrating the filter 320 and converts the second beam L2 into a second optical information L2′. The two sensors 331 and 332 obtains the optical information with different bands, so that the first image processing module 340 and the second image processing module 350 may calculate correctly to obtain the image beam L for a better color restoration.

The first image processing module 340 is disposed in the transmission path of the first optical information L1′ and adapted to convert the first optical information LP into a first image information L1″. The second image processing module 350 is disposed in the transmission path of the first optical information L1′ and the transmission path of the first image information L1″, and adapted to convert the second optical information L2′ into a second image information L2″. The second image processing module 350 integrates the first image information L1″ and the second image information L2″ to output the color image L′.

The embodiment of the invention uses a color encoding method of the image information YUV to represent the optical information of the color image L′. The first image information L1″ includes a brightness information Y for representing the gray scale of the first image information L″ (the image of the infrared light R1). The second image information L2″ includes a brightness information Y and a chroma information UV for representing the brightness, color, and saturation of the second image information L2″ (the image of the visible light R2). With the chroma information UV representing the color and saturation of the color image L′, and with the brightness information Y of the first image information L1″ and the brightness information Y of the second image information L2″ representing the brightness of the color image L′, the color image L′ generated by the image capturing device 300 after capturing the image beam L may obtain a better color restoration. Compared with the color image generated from the conventional single visible light R2, the brightness information Y of the color image L′ may be compensated by the brightness information Y of the first image information L1″, so as to increase the brightness of the color image L′.

In above embodiment, by replacing different filters 320, the first band of the first beam L1 is the wavelength range of the visible light R2, and the second band of the second beam L2 is the wavelength range of the infrared light R1. Thus, the first image information L1″ includes the brightness information Y and the chroma information UV, and the second image information L2″ includes the brightness information Y. The brightness of the color image L′ is compensated by the brightness information Y of the second image information L2″.

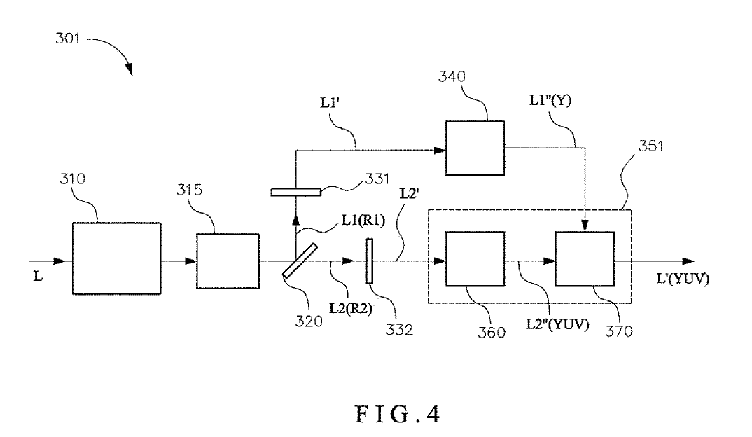

Refer to FIG. 4 for a schematic view of an image capturing device 301 in accordance with the second embodiment of the invention. In the embodiment, the second image processing module 350 in the FIG. 3 is replaced by another second image processing module 351. The second image processing module 351 includes a color restoration module 360 and an image integration module 370. The color restoration module 360 is disposed in the transmission path of the second optical information L2′ and adapted to convert the second optical information L2′ into the second image information L2″. The image integration module 370 is disposed in the transmission paths of the first image information L1″ and the second image information L2″, and adapted to integrate the first image information L1″ and the second image information L2″ to output the color image L′.

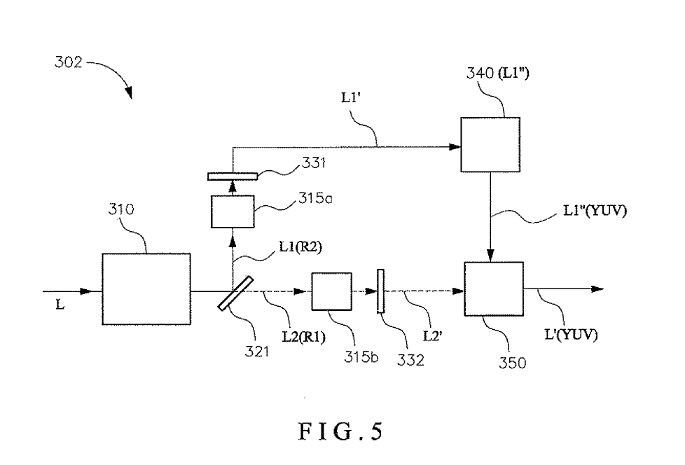

FIG. 5 is a schematic view of an image capturing device 302 in accordance with the third embodiment of the invention. The image capturing device 302 is adapted to capture the image beam L from the external environment and includes a lens module 310, a filter 321, two sensors 331 and 332, a first image processing module 340, and a second image processing module 350.

The lens module 310 is adapted to receive the image beam L. The filter 321 is disposed in the transmission path of the image beam L received by the lens module 310 and adapted to split the image beam L into the first beam L1 and the second beam L2. The filter 321 reflects the first beam L1 and enables the second beam L2 to penetrate. The first beam L1 has a first band, and the first band is the wavelength range of the visible light R2. The second beam L2 has a second band, and the second band is the wavelength range of the infrared light R1.

In an embodiment, the image capturing device 302 further includes two optical modules 315a and 315b disposed between the filter 321 and two sensors 331 and 332. The optical module 315a is disposed in the transmission path of the first beam L1 reflected by the filter 321 for compensating the loss of the first beam L1 and correcting the position of the first beam L1 on the sensor 331, such that the first beam L1 is focus on the sensor 331. The optical module 315b is disposed in the transmission path of the second beam L2 penetrating the filter 312 for compensating the loss of the second beam L2 and correcting the position of the second beam L2 on the sensor 332, so as to focus the second beam L2 on the sensor 332 and avoid the defocus problem of the color image L″ generated by the image capturing device 302.

Two sensors 331 and 332 are separately disposed in the transmission paths of the first beam L1 and the second beam L2. The sensor 331 receives the first beam L1 and converts the first beam L1 into a first optical information L1′, wherein the position of the first beam L1 is amended by the optical module 315a. The sensor 332 receives the second beam L2 and converts the second beam L2 into a second optical information L2′, wherein the position of the second beam L2 is amended by the optical module 315b. Two sensors 331 and 332 respectively receive the optical information with different bands, so that the first image processing module 340 and the second processing module 350 may calculate correctly to obtain the image beam L for a better color restoration.

The first image processing module 340 is disposed in the transmission path of the first optical information L1′, and adapted to convert the first optical information L1′ into the first image information L1″. The second image processing module 350 is disposed in the transmission paths of the first optical information L1′ and the first image information L1″, and adapted to convert the second optical information L2′ into the second image information L2″. The second image processing module 350 integrates the first image information L″ and the second image information L2″ to output the color image L′.

The embodiment uses a color encoding method of the image information YUV to represent the optical information of the color image L′. The first image information L1″ includes a brightness information Y and a chroma information UV for describing the brightness, color, and saturation of the first image information L1″ (the image of the visible light R2). The second image information L2″ includes a brightness information Y for describing the gray scale of the second image information L2″ (the image of the infrared light R1). The chroma information UV represents the color and saturation of the color image L′, and the brightness information Y of the first image information L1″ and the brightness information Y′ of the second image information L2″ represent the brightness of the color image L′, so that the color image L′ generated by the image capturing device 302 after capturing the image beam L may obtain a better color restoration. Compared with the color image generated by the conventional single visible light R2, the brightness information Y of the color image L′ may be compensated by the brightness information Y′ of the second image information L2″, so as to increase the brightness of the color image L′.

In above embodiment, by replacing different filters 321, the first band of the first beam L1 is the wavelength range of the infrared light R1, and the second band of the second beam L2 is the wavelength range of the visible light R2. Thus the first image information L1″ includes a brightness information Y, and the second image information L2″ includes a brightness information Y and a chroma information UV. The brightness of the color image L′ is compensated by the brightness information Y of the first image information L1″.

In summary, the embodiment or embodiments of the invention may have at least one of the following advantages:

1. With the filters 320 and 321, the first image processing module 340 and the second image processing modules 350 and 351 may separately process the optical information of the infrared light R1 and the visible light R2. The optical information of the infrared light R1 is converted into the brightness information Y to compensate the brightness of the color image L′, so that the color image L′ generated by the image capturing devices 300, 301 or 302 after capturing the image beam L may obtain a better color restoration and brightness enhancement.

2. With the optical modules 315, 315a, and 315b, the image beam L emitted by the lens module 310 may be compensated and amended to avoid the defocus problem of the color image L′ generated by the image capturing devices 300, 301, and 302.

The foregoing description of the preferred embodiment of the invention has been presented for purposes of illustration and description. It is not intended to be exhaustive or to limit the invention to the precise form or to exemplary embodiments disclosed. Accordingly, the foregoing description should be regarded as illustrative rather than restrictive. Obviously, many modifications and variations will be apparent to practitioners skilled in this art. The embodiments are chosen and described in order to best explain the principles of the invention and its best mode practical application, thereby to enable persons skilled in the art to understand the invention for various embodiments and with various modifications as are suited to the particular use or implementation contemplated. It is intended that the scope of the invention be defined by the claims appended hereto and their equivalents in which all terms are meant in their broadest reasonable sense unless otherwise indicated. Therefore, the term “the invention”, “the invention” or the like is not necessary limited the claim scope to a specific embodiment, and the reference to particularly preferred exemplary embodiments of the invention does not imply a limitation on the invention, and no such limitation is to be inferred. The invention is limited only by the spirit and scope of the appended claims. The abstract of the disclosure is provided to comply with the rules requiring an abstract, which will allow a searcher to quickly ascertain the subject matter of the technical disclosure of any patent issued from this disclosure. It is submitted with the understanding that it will not be used to interpret or limit the scope or meaning of the claims. Any advantages and benefits described may not apply to all embodiments of the invention. It should be appreciated that variations may be made in the embodiments described by persons skilled in the art without departing from the scope of the invention as defined by the following claims. Moreover, no element and component in the disclosure is intended to be dedicated to the public regardless of whether the element or component is explicitly recited in the following claims.

What is claimed is:

1. An image capturing device, adapted to capture an image beam, comprising:
a lens module, adapted to receive the image beam;
a filter, disposed in a transmission path of the image beam received by the lens module and adapted to split the image beam into a first beam and a second beam;
two sensors, separately disposed in transmission paths of the first beam and the second beam, and adapted to respectively convert the first beam and the second beam into a first optical information and a second optical information separately;
a first image processing module, disposed in a transmission path of the first optical information and adapted to convert the first optical information into a first image information; and
a second image processing module, disposed in transmission paths of the second optical information and the first image information, and adapted to convert the second optical information into a second image information and integrate the first image information and the second image information to output a color image.

2. The image capturing device of claim 1, wherein the first beam has a first band, the second beam has a second band, and the first band is different from the second band.

3. The image capturing device of claim 2, wherein the first band is wavelength range of an infrared light, and the second band is wavelength range of a visible light.

4. The image capturing device of claim 3, wherein the first image information comprises a brightness information, and the second image information comprises a brightness information and a chroma information.

5. The image capturing device of claim 3, wherein the second image processing module comprises a color restoration module and an image integration module, the color restoration module is disposed in the transmission path of the second optical information and adapted to convert the second optical information into the second image information, and the image integration module is disposed in the transmission paths of the first image information and the second image information, and adapted to integrate the first image information and the second image information to output the color image.

6. The image capturing device of claim 1, further comprising an optical module, wherein the optical module is disposed in the transmission path of the image beam received by the lens module, and located between the lens module and the filter, and the optical module is adapted to correct a position of the image beam on the filter.

7. The image capturing device of claim 1, further comprising two optical modules, wherein the optical modules are separately disposed in the transmission paths of the first beam and the second beam split by the filter, and respectively located between the filter and the sensors, and the optical modules are adapted to correct positions of the first beam and the second beam on the sensors separately.
